(19) United States
(12) Patent Application Publication
(10) Pub. No.: US 2003/0192916 A1
(43) Pub. Date: Oct. 16, 2003

(54) Ergonomic handle assembly for dispenser of extrudable material

(76) Inventor: Jeffrey C. Watson, Franklin, TN (US)

Correspondence Address: James M. Singer, Pepper Hamilton LLP, 50th Floor, 500 Grant Street, Pittsburgh, PA, 15219, US

(21) Appl. No.: 10/411,901

(22) Filed: Apr. 11, 2003

Related U.S. Application Data
(60) Provisional application No. 60/372,292, filed on Apr. 12, 2002.

(51) Int. Cl. G01F 11/00

(52) U.S. Cl. 222/391

(57) ABSTRACT

An ergonomic handle assembly is provided for dispensers of food, condiments and other extrudable material. The assembly includes a handle having a first portion adapted to be connected to an elongated dispenser and axially aligned with said dispenser at one end thereof. A second portion has a surface adapted to be gripped by the hand of an operator using the dispenser and is aligned at an angle within a range of from about 140 to about 160 degrees with respect to a direction normal to a longitudinal axis of said first portion. This enables said operator to hold the operator's elbow comfortably against the side of said operator when manipulating the dispenser by rotation of the operator's wrist, thereby reducing fatigue of said operator. A dispenser including the ergonomic handle assembly is also provided.

### RELATED APPLICATION AND CLAIM OF PRIORITY

This application claims the benefit of and priority to U.S. Provisional Application Serial No. 60/372,292, filed Apr. 12, 2002, entitled “Ergonomic Handle Assembly for Dispenser of Extrudable Material,” which is incorporated herein by reference in its entirety.

### FIELD OF THE INVENTION

The present invention relates generally to dispensers of extrudable material. More particularly, the present invention relates to an ergonomic handle assembly for dispensers of extrudable material.

### BACKGROUND OF THE INVENTION

Prior known dispensers of food, condiments or other extrudable material had a straight handle assembly which required a person using the dispenser to hold their elbow at about ninety degrees or so from their body when dispensing material from the dispenser. Thus, a person using such a dispenser would have to hold their arm in an awkward position resulting in considerable fatigue during operation of the dispenser. There is a need for an ergonomic handle assembly for dispensers of extrudable material that would not require a person using the dispenser to hold their arm in an awkward position during operation of the dispenser.

Accordingly, it is desirable to provide an improved handle assembly for a dispenser of extrudable material that would reduce the amount of fatigue of a person operating the dispenser.

### SUMMARY OF THE INVENTION

It is therefore a feature and advantage of the present invention to provide an ergonomic handle assembly for a dispenser of extrudable material that would enable a person operating the dispenser to hold their arm comfortably against their body during operation of the dispenser.

The above and other features and advantages are achieved through the use of a novel handle assembly as herein disclosed. In accordance with a preferred embodiment of the invention, an ergonomic handle assembly for use with a dispenser of extrudable material comprises a handle having a first portion defining a longitudinal axis and adapted to be connected to and axially aligned with one end of said dispenser. A second or handgrip portion of the handle is aligned at an angle with respect to a direction normal to said longitudinal axis of the first portion of the handle. The hand grip portion is adapted to be gripped by the hand of an operator using said dispenser. The ergonomic handle assembly further comprises a trigger assembly rotatably mounted to the handle and adapted to be gripped by the fingers of the hand of said operator using the dispenser. The angle of the hand grip portion of the handle with respect to said direction normal to the longitudinal axis of said first portion of the handle is within a range of from about 140 to about 160 degrees. This enables the operator to hold the operator's elbow comfortably against the side of said operator's body when manipulating the dispenser by rotation of the operator's wrist, thereby reducing fatigue of said operator. Preferably, said angle is within a range of about 145 to about 155 degrees.

In accordance with an alternate embodiment of the invention, a dispenser for extrudable material comprises an elongated hollow body portion for holding extrudable material, and a handle assembly at one end of said body portion. The handle assembly includes a handle a first portion defining a longitudinal axis connected to and axially aligned with one end of said hollow body portion of the dispenser. A hand grip portion of the handle is adapted to be gripped by the hand of an operator using the dispenser. The hand grip portion is aligned at an angle with respect to a direction normal to a longitudinal axis of the body portion of said dispenser and said first portion of the handle. A trigger assembly is rotatably mounted to said handle and is adapted to be gripped by the fingers of the hand of the operator using said dispenser. The dispenser also includes a means actuable by said trigger assembly for dispensing said extrudable material from the body portion of said dispenser. The angle of said hand grip portion with respect to said direction normal to the longitudinal axis of the body portion is within a range of about 140 to about 160 degrees. This enables the operator to hold the operator's elbow comfortably against the side of said operator's body when manipulating the dispenser by rotation of the operator's wrist, thereby reducing fatigue of said operator. Preferably, said angle is within a range of about 145 to about 155 degrees.

It is to be understood that the invention is not limited in its application to the details of construction and to the arrangements of the components set forth herein or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be used as a basis for designing other structures, methods and systems for carrying out the several purposes of the invention. Thus, the invention is not limited to the exact construction and operation illustrated and described, and accordingly all appropriate modifications and equivalents may fall within the scope of the invention.

### BRIEF DESCRIPTION OF THE DRAWINGS

FIG. 1 provides an isometric plan view illustrating several elements of a preferred embodiment of the present invention.

FIG. 2 provides an exploded isometric view illustrating in more detail the several elements of the preferred embodiment of FIG. 1.

### DETAILED DESCRIPTION OF PREFERRED EMBODIMENTS OF THE INVENTION

A preferred embodiment of the present invention provides an ergonomic handle assembly for a dispenser of extrudable material wherein an outer gripping surface of the handle is aligned at a critical angle of 150±10 degrees, preferably 150±5 degrees, with respect to a direction normal to a longitudinal axis of the dispenser.

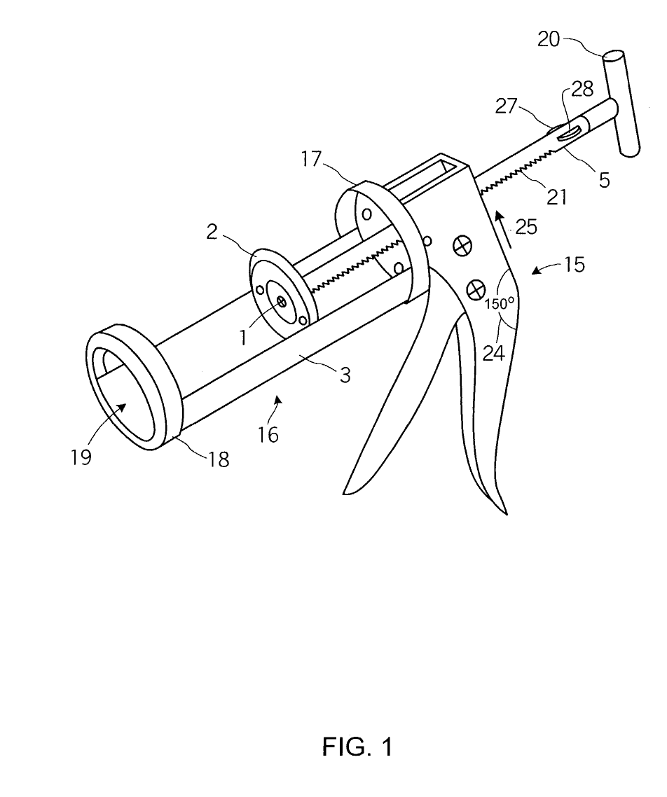

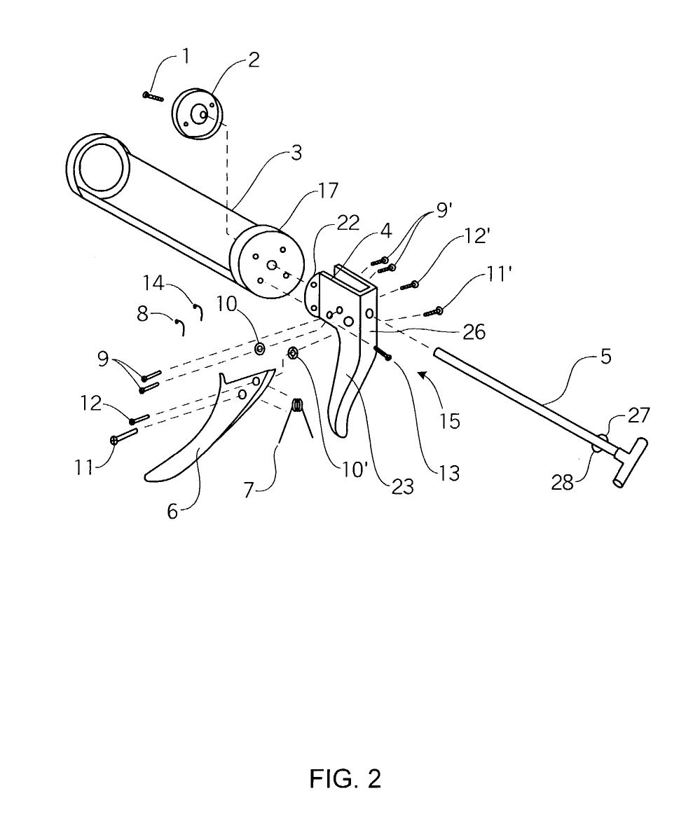

A preferred embodiment of the present inventive apparatus is illustrated in FIG. 1. Handle assembly 15 is shown attached to a conventional dispenser 16 for example of the type including a semi-cylindrical body portion 3 having a first circular end cap 17 secured for example by welding to one end of body portion 3 proximate the handle assembly. A second circular end cap 18 having a circular opening 19 is secured for example by welding to body portion 3 at an end remote from the handle assembly. A cylinder drive rod 5 is mounted centrally through end cap 17 and has circular pusher plate 2 secured to one end within body portion 3 by screw 1. A handle 20 is attached to an opposite end of cylinder drive rod 5. Cylinder drive rod 5 has a plurality of teeth 21 on one side surface thereof. A plurality of stops, for example in the form of protrusions 27 and 28, on cylinder drive rod 5 preferably engage an outer surface of handle 26 (FIG. 2) and prevent jamming at the end of a stroke of the cylinder rod.

Referring to FIG. 2, handle assembly 15 includes for example a generally rectangular hollow box shape handle 26. Handle 26 has opposed flanges, one of which is shown at 22. Each flange has two holes aligned with holes in end cap 17 for receiving screws, one of which is shown at 13, for securing handle 26 to end cap 17. The handle assembly includes a trigger 6 adapted to be mounted within handle 26. Threaded post 12 and screw 12′ extend through corresponding mateable hole openings in handle 26 and trigger 6 and pass through an opening in wratchet 10′ so as to mount wratchet 10′ on post 12. Similarly, threaded post 11 and screw 11′ extend through corresponding mateable hole openings in trigger 6 and pass through large spring 7 so as to mount large spring 7 on post 11. Two threaded posts 9 and two screws 9′ extend through corresponding mateable openings in handle 26 and pass through an opening in pawl 10 so as to mount pawl 10 on one of posts 9. Pawl 10 coacts with wratchet 10′ for advancing cylinder drive rod 5 through engagement with teeth 21 on rod 5 each time trigger 6 is actuated. Small spring 8 and spring arc 14 are mounted on the other threaded post 9 from the one on which pawl 10 is mounted so as to bias pawl 10 against wratchet 10′ causing wratchet 10′ to be biased into engagement with teeth 21 of rod 5.

When trigger 6 is actuated, the dispenser assembly 16 will preferably dispense a predetermined amount of material, depending on the dimensions of the container that holds the material, as well as the dimensions of the various components of dispenser assembly 16. Handle 26 and cylinder drive rod 5 are adapted by virtue of the spacing of teeth 21 on rod 5 and wratchet 10′ of specified dimensions to engage teeth 21 to dispense a metered predetermined amount of material. Cylinder rod 5 may be easily removed by removing screw 1 from pusher plate 2 and withdrawing rod 5 through handle 26. Similarly, handle 26 may be quickly and easily changed by removal of screws 13 from flanges 22 and end cap 17. A replacement handle and cylinder rod adapted to dispense a different amount of metered material may then be installed by the reverse procedure. Accordingly, the parts of the dispenser may be quickly and easily changed so as to dispense various predetermined amounts of material. Preferably, each handle and cylinder rod are coded, for example, by color coding to insure that the proper corresponding handle and cylinder rod are used for dispensing the appropriate amount of material desired.

According to this invention, handle 26 has an outer curved hand grip portion 23 adapted to be gripped by the hand of a person using the dispenser, said hand grip portion adapted to be aligned at an angle 24 of 150±10 degrees, preferably 150±5 degrees, with respect to a direction 25 normal to a longitudinal axis of dispenser 16. This angle is critical for reducing the amount of fatigue of a person using a dispenser having the handle assembly of this invention. A handle having a hand grip portion at this angle permits a person using the dispenser to grip the outer portion of the handle and hold their elbow comfortably against their side using a simple rotation of their wrist to manipulate the position of the dispenser.

The many features and advantages of the invention are apparent from the detailed specification. Thus, the appended claims are intended to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

I claim:

1. An ergonomic handle assembly for use with an elongated dispenser of extrudable material, comprising:
a handle having a first portion adapted to be connected to said elongated dispenser and axially aligned with said dispenser at one end thereof, a second portion having a surface adapted to be gripped by the hand of an operator using said dispenser, and a trigger assembly rotatably mounted to said handle adapted to be gripped by the fingers of the hand of said operator,
said surface adapted to be gripped by the hand of said operator being aligned at an angle within a range of from about 140 to about 160 degrees with respect to a direction normal to a longitudinal axis of said first portion so as to enable said operator to hold said operator's elbow comfortably against the side of said operator when manipulating the dispenser by rotation of the operator's wrist.

2. The handle assembly of claim 1, wherein said angle is within a range of about 145 to about 155 degrees.

3. A dispenser for extrudable material, comprising:
an elongated hollow body portion for holding extrudable material; and
a handle assembly at one end of said body portion;
said handle assembly including a handle a first portion connected to said elongated body portion and axially aligned with said body portion at one end thereof, a hand grip portion adapted to be gripped by the hand of an operator using said dispenser, and a trigger assembly rotatably mounted to said handle and adapted to be gripped by the fingers of the hand of said operator; and
means actuable by said trigger assembly for dispensing said extrudable material from the body portion of said dispenser;
wherein the angle of said hand grip portion of the handle with respect to a direction normal to a longitudinal axis of said body portion and said first portion of the handle is within a range of about 140 to about 160 degrees so as to enable an operator to hold said operator's elbow comfortably against the side of said operator when manipulating the dispenser by rotation of the operator's wrist.

4. The dispenser of claim 3 wherein said angle of the hand grip portion of the handle is within a range of about 145 to about 155 degrees.

5. The dispenser of claim 3 wherein said dispenser dispenses a predetermined amount of material upon each actuation of said trigger assembly.

6. The dispenser of claim 5 wherein said dispenser further comprises a cylinder rod and a pusher plate connected to said cylinder rod, said cylinder rod having teeth of specific dimensional spacing for advancing said pusher plate an appropriate distance upon actuation of said trigger assembly in order to dispense said predetermined amount of material.

7. The dispenser of claim 6 wherein said cylinder rod and said handle assembly are readily detachable from said dispenser in order to permit installation of another said handle assembly and cylinder rod adapted to dispense a different amount of material than the first mentioned handle assembly and cylinder rod.

8. The dispenser of claim 7 wherein said cylinder rod and handle assembly are coded so as to ensure installation of the appropriate handle assembly and cylinder rod for dispensing each predetermined amount of material desired.
